(19) United States
(12) Patent Application Publication
(10) Pub. No.: US 2026/0133659 A1
(43) Pub. Date: May 14, 2026

(54) ELECTRONIC APPARATUS AND CONTROLLING METHOD THEREOF

(71) Applicant: SAMSUNG ELECTRONICS CO., LTD., Suwon-si (KR)

(72) Inventors: Shashi SINGH, Noida (IN); Manishkumar Madankumar DAS, Noida (IN); Rahul SINGH, Noida (IN)

(73) Assignee: SAMSUNG ELECTRONICS CO., LTD., Suwon-si (KR)

(21) Appl. No.: 19/371,756

(22) Filed: Oct. 28, 2025

Related U.S. Application Data
(63) Continuation of application No. PCT/KR2025/015368, filed on Sep. 29, 2025.

(30) Foreign Application Priority Data
Oct. 1, 2024 (IN) 202411074213

(51) Int. Cl. G06F 3/041; G06F 3/04842; G06F 3/04886

(52) U.S. Cl. CPC G06F 3/04186; G06F 3/04886; G06F 3/04842

(57) ABSTRACT

An electronic apparatus includes: at least one processor including processing circuitry, memory configured to store instructions, and a display, wherein the instructions, when executed by the at least one processor individually or collectively, cause the electronic apparatus to: obtain sensing data including at least one of microphone data and inertial sensor data, identify a touch input on the display based on the sensing data, identify a touch region corresponding to the touch input from among regions of the display, identify a target object corresponding to the touch input, from among a plurality of objects associated with the touch input based on the touch region, and perform an operation corresponding to the target object.

### CROSS-REFERENCE TO RELATED APPLICATIONS

This application is a bypass continuation of International Application No. PCT/KR 2025/015368, filed on Sep. 29, 2025, which is based on and claims priority to Indian Patent Application No. 202411074213, filed on Oct. 1, 2024, in the Intellectual Property India, the disclosures of which are incorporated by reference herein in their entireties.

### BACKGROUND

### 1. Field

The present disclosure relates to the field of electronic devices, and more particularly, to a system and a method for performing an operation on a display of a user device.

### 2. Description of Related Art

Touchscreens have become ubiquitous in modern touch-enabled electronic devices such as smartphones, tablets, and wearables. The touch interface provided by such touchscreens allows users to interact with devices via direct touch inputs, making them intuitive and easy to use. The two primary technologies for touchscreens are capacitive touch and resistive touch.

Capacitive touch relies on the electrical properties of the human body to detect touch. The touchscreen surface is typically coated with a transparent conductor, such as indium tin oxide (ITO), which creates an electrostatic field. When a user touches the screen, the electrostatic field is disturbed, causing a measurable change in capacitance. This change is detected by sensors located at various points on the screen, enabling the device's controller to determine the exact touch location.

Resistive touch, on the other hand, uses two flexible layers separated by a small gap. These layers are coated with a resistive material. When pressure is applied to the surface, the layers come into contact, causing a change in resistance at the point of touch. The controllers associated with the device process the resistance change to determine the location of the input.

Both capacitive and resistive touchscreens have their own respective limitations. Capacitive touchscreens, while highly responsive, can face issues in certain environmental conditions or usage scenarios. For instance, the capacitive technology may fail to detect touch input when the screen or the user's hand is wet, greasy, or covered with gloves, or when used underwater. Resistive touchscreens, although more reliable in such scenarios, require more pressure for input and are less sensitive to lighter touches.

Therefore, in view of the above-mentioned limitations, it is desirable to provide a system and a method that may eliminate, or at least, mitigate one or more of the above-mentioned problems associated with the existing solutions.

### SUMMARY

This summary is provided to introduce a selection of concepts, in a simplified format, that are further described in the detailed description of the present disclosure. This summary is neither intended to identify key or essential inventive concepts of the present disclosure and nor is it intended for determining the scope of the present disclosure.

According to an aspect of the disclosure, an electronic apparatus includes: at least one processor including processing circuitry, memory configured to store instructions, and a display, wherein the instructions, when executed by the at least one processor individually or collectively, cause the electronic apparatus to: obtain sensing data including at least one of microphone data and inertial sensor data, identify a touch input on the display based on the sensing data, identify a touch region corresponding to the touch input from among regions of the display, identify a target object corresponding to the touch input, from among a plurality of objects associated with the touch input based on the touch region, and perform an operation corresponding to the target object.

The instructions, when executed by the at least one processor individually or collectively, may cause the electronic apparatus to: control the display to display a screen including the plurality of objects, based on the touch input being identified, identify the target object from among the plurality of objects.

The instructions, when executed by the at least one processor individually or collectively, may cause the electronic apparatus to: identify the touch region based on at least one grid cell corresponding to the touch input, from among a plurality of grid cells associated with at least one of pixels of the display, and identify the target object based on the at least one grid cell corresponding to the touch input.

The instructions, when executed by the at least one processor individually or collectively, may cause the electronic apparatus to: obtain at least one of a click pattern, a model score and a plurality of contextual touch interaction parameters, obtain a confidence score corresponding to the touch input based on the at least one of the click pattern, the model score and the plurality of contextual touch interaction parameters, and identify the touch region based on the confidence score.

The instructions, when executed by the at least one processor individually or collectively, may cause the electronic apparatus to: normalize the sensing data to a single scale, segment the normalized sensing data for one or more time intervals indicating individual time points at which the normalized sensing data are segmented for further processing, concatenate the segmented data into a single feature vector for each time interval of the one or more time intervals, and identify the at least one of the click pattern and the model score using a pre-trained artificial neural network module based on the concatenated segmented data.

The plurality of contextual touch interaction parameters may include at least one of: clickability data indicating whether a grid cell is clickable, historical data representing user interactions indicating regions which are intentionally frequently touched, and contextual data indicating a relationship between the touch input and a current context.

The instructions, when executed by the at least one processor individually or collectively, may cause the electronic apparatus to: based on at least two target objects corresponding to the touch input being identified, identify at least one conflicting grid cell from among the plurality of grid cells.

The instructions, when executed by the at least one processor individually or collectively, may cause the electronic apparatus to: based on the at least one conflicting grid cell being identified, obtain a comparison result by comparing the confidence score with a predetermined threshold associated with a touch proximity, and identify the touch region based on the comparison result.

The instructions, when executed by the at least one processor individually or collectively, may cause the electronic apparatus to, based on the confidence score being smaller than the predetermined threshold, identify the touch input as an incorrect touch.

The instructions, when executed by the at least one processor individually or collectively, may cause the electronic apparatus to, based on the confidence score being equal or greater than the predetermined threshold, control the display to display a screen including the at least two objects in an enlarged size.

According to an aspect of the disclosure, a method of controlling an electronic apparatus, the method includes: obtaining sensing data including at least one of microphone data and inertial sensor data, identifying a touch input on a display of the electronic device based on the sensing data, identifying a touch region corresponding to the touch input from among regions of the display, identifying a target object, corresponding to the touch input, from among a plurality of objects associated with the touch input based on the touch region, and performing an operation corresponding to the target object.

The method may further include: displaying, by the display, a screen including the plurality of objects, and the identifying the target object includes, based on the touch input being identified, identifying the target object from among the plurality of objects.

The identifying the touch region may include identifying the touch region based on at least one grid cell corresponding to the touch input from among a plurality of grid cells associated with at least one of pixels of the display, and the identifying the target object includes identifying the target object based on the at least one grid cell corresponding to the touch input.

The identifying the touch region may include: obtaining at least one of a click pattern, a model score and a plurality of contextual touch interaction parameters, obtaining a confidence score corresponding to the touch input based on the at least one of the click pattern, the model score and the plurality of contextual touch interaction parameters, and identifying the touch region based on the confidence score.

The obtaining at least one of the click pattern, the model score, and the plurality of contextual touch interaction parameters may include: normalizing the sensing data to a single scale, segmenting the normalized sensing data for one or more time intervals, wherein the one or more time intervals indicate individual time points at which the normalized sensing data are segmented for further processing, concatenating the segmented data into a single feature vector for each time interval of the one or more time intervals, and obtaining the at least one of the click pattern and the model score using a pre-trained artificial neural network module based on the concatenated data.

The plurality of contextual touch interaction parameters may include at least one of: clickability data indicating whether a grid cell is clickable, historical data representing user interactions indicating regions which are intentionally frequently touched, and contextual data indicating a relationship between the touch input and a current context.

The identifying the touch region may further include, based on at least two target objects corresponding to the touch input being identified, identifying at least one conflicting grid cell from among the plurality of grid cells.

The identifying the touch region may further include: based on the at least one conflicting grid cell being identified, obtaining a comparison result by comparing the confidence score with a predetermined threshold associated with a touch proximity, and identifying the touch region based on the comparison result.

The identifying the touch region may further include, based on the confidence score being smaller than the predetermined threshold, identify the touch input as an incorrect touch.

The identifying the touch region may further include, based on the confidence score being equal or greater than the predetermined threshold, control the display to display a screen including the at least two objects in an enlarged size.

In another embodiment, the present disclosure provides a system for performing an operation on a display of a user device. The system includes a memory, and at least one processor in communication with the memory. The at least one processor is configured to determine a touch based on at least one of a microphone data and an inertial sensor data on a user interface (UI) of the user device by a user. The at least one processor is further configured to predict at least one grid cell associated with the touch from a segmented one or more pixels of the UI associated with the user device. The at least one processor is further configured to detect, an intended UI object from one or more UI objects associated with the touch based on the at least one predicted grid cell. The at least one processor is further configured to perform an operation associated with the detected intended UI object.

To further clarify the advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an architectural overview of a system for performing an operation on a display of a user device, according to an embodiment of the present disclosure;

FIG. 2 illustrates a flow diagram of activation of a non-conductive touch environment, according to an embodiment of the present disclosure;

FIG. 3A illustrates a schematic diagram depicting a segmentation of one or more pixels and pixel mapping, according to an embodiment of the present disclosure;

FIG. 3B illustrates an example embodiment for computing a vertical touch position on user device using dual-microphone sound data, according to an embodiment of the present disclosure ;

FIG. 4A illustrates a block diagram for determining a click pattern, according to an embodiment of the present disclosure;

FIG. 4B illustrates an example embodiment of a click pattern, according to an embodiment of the present disclosure;

FIG. 5 illustrates a schematic diagram of a touch delegation, according to an embodiment of the present disclosure;

FIG. 6 illustrates a method for performing an operation on a display of a user device, according to an embodiment of the present disclosure;

FIG. 7 illustrates a system for performing an operation on a display of a user device, according to an embodiment of the present disclosure; and

FIG. 8 illustrates a method for performing an operation on a display of a user device, according to an embodiment of the present disclosure.

### DETAILED DESCRIPTION

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates. Unless otherwise defined, all technical and scientific terms used herein have the same meaning as commonly understood by one of ordinary skilled in the art to which this disclosure belongs. The system, methods, and examples provided herein are illustrative only and not intended to be limiting.

Further, skilled artisans will appreciate that elements in the drawings are illustrated for simplicity and may not have necessarily been drawn to scale. For example, the flowcharts illustrate the method(s) in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

For example, the term “some” as used herein may be understood as “none” or “one” or “more than one” or “all.” Therefore, the terms “none,” “one,” “more than one,” “more than one, but not all” or “all” would fall under the definition of “some.” It should be appreciated by a person skilled in the art that the terminology and structure employed herein is for describing, teaching, and illuminating some embodiments and their specific features and elements and therefore, should not be construed to limit, restrict, or reduce the spirit and scope of the present disclosure in any way.

For example, any terms used herein such as, “includes,” “comprises,” “has,” “consists,” and similar grammatical variants do not specify an exact limitation or restriction, and certainly do not exclude the possible addition of one or more features or elements, unless otherwise stated. Further, such terms must not be taken to exclude the possible removal of one or more of the listed features and elements, unless otherwise stated, for example, by using the limiting language including, but not limited to, “must comprise” or “needs to include.”

Whether or not a certain feature or element was limited to being used only once, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language including, but not limited to, “there needs to be one or more . . .” or “one or more element is required.”

Herein, the expression such as “at least one of,” when preceding a list of elements, modifies the entire list of elements and do not modify the individual elements of the list. For example, the expression, “at least one of A, B, and C,” should be understood as including only A, only B, only C, both A and B, both A and C, both B and C, or all of A, B, and C.

Unless otherwise defined, all terms and especially any technical and/or scientific terms, used herein may be taken to have the same meaning as commonly understood by a person ordinarily skilled in the art.

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

Embodiments of the present disclosure will be described below in detail with reference to the accompanying drawings.

Throughout, the present disclosure, the term “system” may refer to the overall messaging system or platform where the present disclosure is implemented. It includes all the components necessary for sending, receiving, and managing messages.

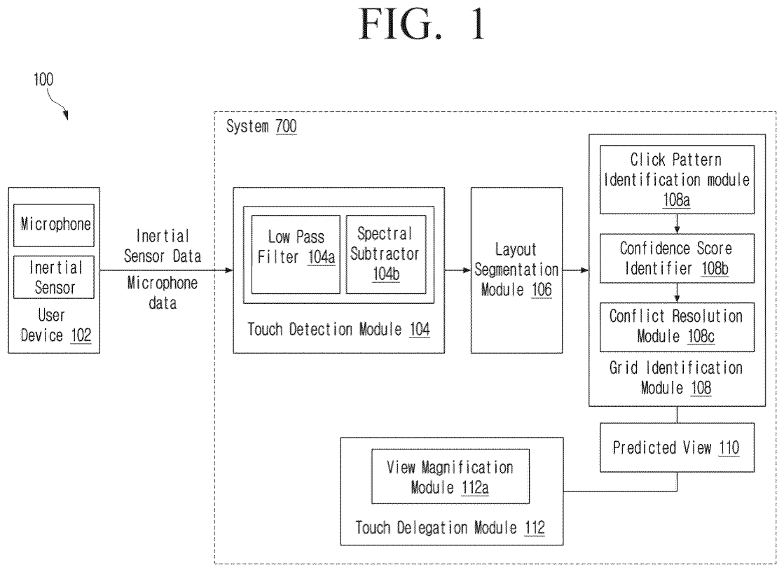

FIG. 1 illustrates an architectural overview 100 of a system for performing an operation on a display of a user device 102, according to an embodiment of the present disclosure.

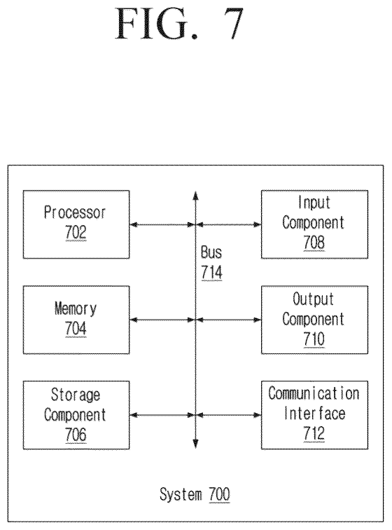

The user device 102 may include a system 700 for performing an operation on a display of a user device 102, which will be described in greater detail in conjunction with FIG. 7. The system 700 may include a touch detection module 104, a layout segmentation module 106, a grid identification module 108, a predicted view module 110, and a touch delegation module 112.

In an example, the user device 102 may include but not limited to a touch-enabled device such as a smartphone, a tablet, a phablet, a laptop, a desktop, and the like.

The touch detection module 104 may include a low-pass filter 104a and a spectral subtractor 104b.

The grid identification module 108 may include a click pattern identification module 108a, a confidence score identifier 108b, and a conflict resolution module 108c. Further, the touch delegation module 112 may include a view magnification module 112a.

In operation, when a user intends to operate the user device 102 in a non-conductive touch environment, the user may activate the non-conductive touch capability in the user device 102. The non-conductive touch capability refers to a setting or mode in which the user interacts with the touch-enabled devices in conditions where traditional touch input, which relies on the conductive properties of the human body (such as a finger), may not be effective. In such an environment, the user activates a special mode on the device that allows recognition and response to touch inputs without relying on conductivity. In an embodiment of the present disclosure, the non-conductive touch environment may be useful when wearing gloves, using a stylus, or interacting with the device through other non-conductive materials.

In one embodiment, the activation of the non-conductive touch capability in the user device 102 may be performed by pressing both volume up and volume down buttons simultaneously for a predefined time. In one embodiment, the predefined time may be 2 seconds. In another embodiment, the predefined time may be 3 seconds. Further, in another embodiment, the non-conductive touch environment may be automatically switched when the user device 102 detects the non-conductive touch environment.

In an embodiment of the present disclosure, upon the activation of the non-conductive touch capability, the user device 102 may provide feedback to the user. In one embodiment, the feedback may be vibration feedback. In another embodiment, the feedback may be a notification on the user device 102 upon activation.

Similarly, the non-conductive touch capability in the user device 102 may be deactivated by pressing both the volume up and the volume down buttons simultaneously for a predefined time. In one embodiment, the predefined time may be, for example, two (2) seconds. In another embodiment, the predefined time may be, for example, three (3) seconds.

In an embodiment of the present disclosure, upon the deactivation of the non-conductive touch environment, the user device 102 may provide feedback to the user. In one embodiment, the feedback may be vibration feedback. In another embodiment, the feedback may be a notification on the user device 102 upon deactivation.

Upon activating the non-conductive touch environment, the touch detection module 104 may determine a touch on a user interface (UI) of the user device 102 based on at least one of microphone data and an inertial sensor data. The microphone data and the inertial sensor data are associated with the user device 102. The touch detection module 104 while detecting the touch may filter out noise in the microphone data using the low-pass filter 104a and the spectral subtractor 104b. The low-pass filter 104a removes high-frequency noise components and the spectral subtractor 104b estimates and subtracts noise spectrum from a noisy signal spectrum in the microphone data.

In an embodiment, the touch detection module may determine the touch based on detecting a trigger input from the user to initiate determination of the touch input. According to the embodiments of the present disclosure, detecting the trigger input indicates the process of recognizing a specific action or signal from the user that indicates an intention of the user to interact with the UI. In an example, the trigger input may be activating the user device 102 to the non-conductive touch environment.

Following the determination of the touch based on a the microphone data and the inertial sensor data, the layout segmentation module 106 segments one or more pixels of the UI associated with the user device 102. The segmentation process begins by capturing one or more bitmap images of a UI layout from the user device 102, utilizing a drawing cache. The drawing cache stores a version of a visual content at a specific time instance, allowing the bitmap image to accurately reflect the visual state of the UI. After capturing the bitmap image, an edge detection technique is applied to identify boundary pixels within the bitmap image, marking the edges of various UI objects. An UI object is an interactive element on a screen of the user device 102 that the user can interact with. In an embodiment, the various UI objects may include icons, buttons, text fields, sliders, or any other graphical element that performs a specific function or represents an application. Following the edge detection, the process detects a one or more UI object boundaries that correspond to the one or more UI objects, outlining shapes and distinguishing each UI object from the surrounding elements. Finally, a bounding box is computed for each detected UI object boundary to determine the size and the position of a view within the layout which results in the segmented one or more pixels where each UI object is clearly defined and localized based on its spatial properties.

For example, in a mobile application interface, the segmentation process may capture a bitmap of the screen, detect the boundaries of buttons and text fields, and compute the bounding box for each UI object boundary to segment the one or more pixels into distinct parts for further analysis or modification.

Once the one or more pixels are segmented, the grid identification module 108 predicts at least one grid cell associated with the touch from the segmented one or more pixels of the UI associated with the user device 102. A grid cell corresponds to a distinct section of the screen of the user device 102. The grid cell is created based on division of a screen of the user device 102 into a grid-like structure. In an embodiment, each grid cell represents a specific area of the screen and may contain one or more UI objects (also referred to as UI elements, icons, or applications). In another embodiment, the grid cell may contain one complete UI object, multiple UI objects, part of a larger UI object and the like.

In an embodiment, the prediction of the at least one grid cell associated with the touch may be achieved by training a machine learning model. The training of a grid cell prediction model begins by defining a fixed-size grid over the touchable area of the screen of the user device 102. The grid is divided into multiple smaller cells, each representing a specific region of the UI screen. Touch data is then collected from users interacting with various UI objects and screens, where each touch event is recorded along with its corresponding grid cell location and the UI object being touched. The touch data is then preprocessed to align with the grid structure, ensuring that each touch point is accurately mapped to a grid cell.

Once the touch data is prepared, relevant features are extracted from the touch data. The relevant features may include the exact touch coordinates within the grid and sensor information such as inertial sensor data and the microphone data from the user device 102 to capture factors that might influence the prediction of the touch. A correct grid cell for each touch is labeled, creating a supervised learning scenario where the model learns to predict which grid cell was touched based on the relevant features extracted from the touch data.

The machine learning models such as convolutional neural networks may be trained on the labeled dataset by feeding the relevant features and adjusting the predictions of the machine learning model iteratively to match the true grid cell labels. The process involves multiple training cycles, during which the ability of the machine learning model is refined to predict the correct grid cells based on the touch data.

The prediction of the at least one grid cell associated with the touch may include determining a confidence score associated with the touch action of the at least one grid cell by the confidence score identifier 108b. The confidence score is determined based on a determining of at least one of a click pattern, a model score and a plurality of contextual touch interaction parameters associated with the UI of the user device 102.

In an embodiment, the click pattern refers to a unique interaction signature or a fingerprint or a pattern associated with a user touch or click on a specific icon or the UI object. Each UI object, such as a Google™ icon, calculator icon, or voicemail icon, may have a different click pattern based on how the user interacts with a corresponding UI object. The plurality of contextual touch interaction parameters may include a view clickability data indicating a data if the grid cell is clickable or not based on the UI object, a historical data representing past user interactions indicating areas which are intentionally frequently touched, and a contextual data associated with the user of the user device 102 indicating a relationship of the touch action to a current context.

In an example scenario where the user is interacting with a smartphone application, such as a shopping application, and taps on a product thumbnail to view more details. The UI of the application is segmented into one or more pixels, and when the user touches the screen, the grid identification module 108 comes into play.

Once the one or more pixels are segmented, the grid identification module 108 predicts which grid cell the user has interacted with. For example, if the user taps on the product thumbnail, the grid identification module 108 identifies the specific grid cell that contains the thumbnail. Further, to ensure accuracy, the confidence score identifier 108b computes the confidence score by evaluating various factors. The various factors may include the click pattern (e.g., the frequency and precision of their touches), a model score derived from a neural network trained on similar interactions, and contextual touch interaction parameters like how firmly and how long the user pressed the screen.

Based on the above information, the grid identification module 108 predicts that the user has selected the product thumbnail, and the application then loads the detail page of the product. The entire process happens in real-time, ensuring that the application responds accurately and quickly to the user's touch.

The confidence score is determined based on the determination of the click pattern. To determine the click pattern, the click pattern identification module 108a involves several steps involving both inertial sensor data and microphone data. Initially, the click pattern identification module 108a normalizes the inertial sensor data and the microphone data, by adjusting onto a common scale for consistent analysis. Further the inertial sensor data is smoothed to remove any irregularities, and relevant characteristics for further processing are extracted from the microphone data by applying feature engineering. The feature engineering is the process of transforming a raw data into meaningful features that can be used effectively by machine learning models. The machine learning models involves selecting, modifying, or creating new input variables (features) from raw data to improve the performance and accuracy of the machine learning models.

Upon normalizing the inertial sensor data and the microphone data, the click pattern identification module 108a may be configured to segment the inertial sensor data and the microphone data into one or more time intervals, with each interval representing a specific point in time during the user interaction. The one or more segmented time intervals captures individual moments when the user interacts with the user device 102, such as taps or gestures. The segmented data from the inertial sensor and the microphone data is then concatenated into a single feature vector for each time interval, consolidating all relevant input data into a unified representation.

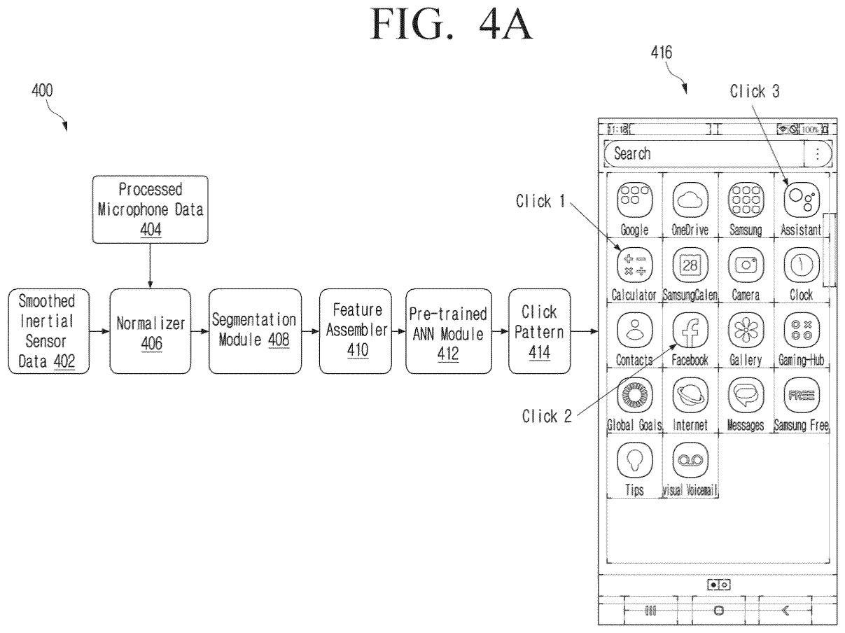

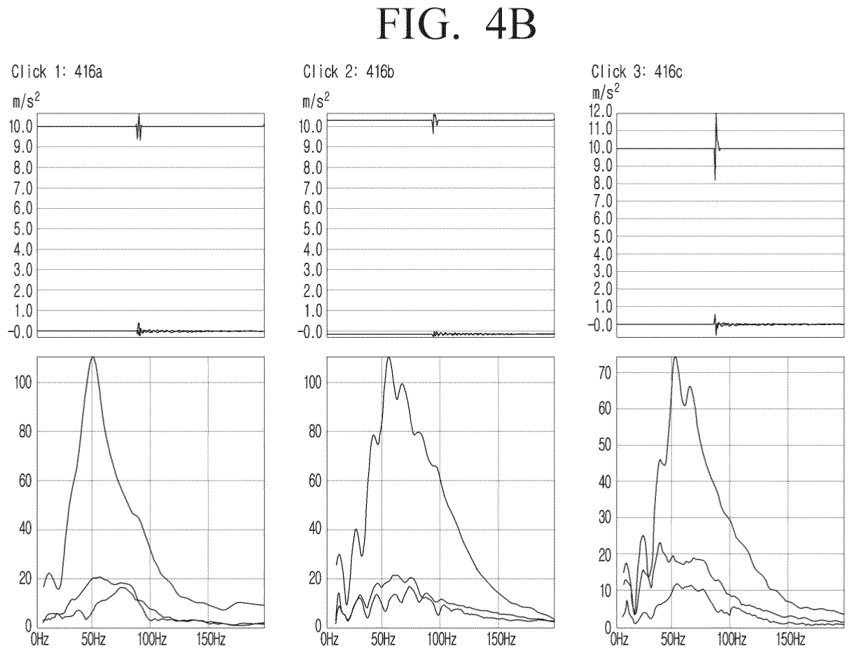

Further, the concatenated feature vectors are fed into a pre-trained artificial neural network (ANN) module (for example, pre-trained ANN module 412 of FIG. 4A). The pre-trained ANN module processes the data to determine the click pattern, which might include information like how frequently and precisely the user taps or interacts with the screen. In another embodiment, the pre-trained ANN module may also compute a model score, which helps evaluate the reliability and accuracy of the detected click pattern. The determined click pattern, along with other contextual data, is then used to predict the user actions, such as selecting a UI element or triggering a specific function on the device.

In an example scenario, imagine a user is interacting with a fitness tracking application on his smartphone while jogging. The application uses inertial sensor such as an accelerometer and a microphone to detect specific interactions, such as tapping to change between workout modes. As the user jogs, the application records inertial sensor data (e.g., accelerometer readings) that capture the movement and force of the user taps, along with microphone data that captures sound cues related to taps (such as the vibration caused by the tap or sound of contact with the screen). In an embodiment, the grid identification module 108 first normalizes the inertial sensor and microphone data by adjusting to a common scale for consistency. Next, the click pattern identification module 108a smooths the inertial sensor data to remove irregularities caused by jogging motion of the user, which could introduce noise or fluctuations. Simultaneously, the feature engineering is applied to the microphone data to extract relevant characteristics, such as sound amplitude and frequency, which might indicate the intensity or precision of the tap.

After normalization, the click pattern identification module 108a segments the processed microphone data 404 into specific time intervals. Each interval represents a moment when the user interacts with the user device 102, like a tap between steps. For example, as the user taps the screen to switch workout modes, the segmented data captures that exact moment of interaction. The segmented time intervals are then combined into a single feature vector that represents all relevant data from the inertial sensor and the microphone for each tap. The feature vectors are then fed into the pre-trained ANN module, which has been trained to recognize the click patterns in user taps. The pre-trained ANN module is configured to analyze how frequently and precisely the user taps while jogging, determining the click pattern. Using the click pattern the confidence score is computed by the confidence score identifier 108b. Once the grid identification module 108 identifies the grid cells a predicted view is generated by the predicted view module 110 for further processing.

Upon predicting the at least one grid cell associated the touch, the touch delegation module 112 may further detect an intended UI object from one or more UI objects associated with the touch based on the at least one predicted grid cell. The touch delegation module 112 may further configured to detect the intended UI object based on mapping the determined set of pixel coordinates to a dynamic mapping data present in a mapping table associated with the one or more UI objects. The set of pixel coordinates refers to specific points on the UI where the user interacts, such as by touching or clicking. The set of pixel coordinates are defined in terms of horizontal and vertical positions (x, y) on the display grid, essentially pinpointing the exact location of the user interaction. For example, when a user taps on the “Submit” button, the system 700 captures the corresponding pixel coordinates of that touch and then references these coordinates in the mapping table to verify that they align with the “Submit” button, rather than a neighboring element (as detailed in the following paragraphs). For example, in a photo editing application, the user taps on a specific tool icon in the toolbar. The touch delegation module 112 predicts the grid cell corresponding to the touch location and detects the intended UI object (the tool icon) by mapping the pixel coordinates of the touch to the mapping table that associates different UI objects with their respective coordinates which ensures the correct tool is selected based on the user's tap, even if the touch is near the edge of the icon.

In an embodiment, the at least one predicted grid cell associated the touch corresponds to either the intended UI object or at least one conflicting grid cell. The at least one conflicting grid cell is associated with at least one of at least two UI objects of the one or more UI objects. The at least two UI objects include the intended UI object and another UI object.

In an embodiment, when the predicted grid cell corresponds to at least one conflicting grid cell, the touch delegation module 112 initiates a process to detect the intended UI object from the one or more UI objects present within the conflicting area. This detection is performed by comparing the confidence score of the touch action with a predetermined threshold that is associated with the proximity of the touch. In one embodiment, when the confidence score is below the predetermined threshold, the touch delegation module 112 may classify the touch as incorrect.

In an example, a user is interacting with a messaging application of a smartphone. The user intends to tap on a “Send” button, but the touch occurs in a conflicting grid cell that overlaps both the “Send” button and a nearby “Attachment” icon. The touch delegation module 112 initiates a process to detect the intended UI object from the two conflicting UI objects. In an example scenario, the touch delegation module 112 may calculate the confidence score based on the proximity of the touch of the user to each UI object. In an example embodiment, the confidence score for “Send” button is 0.75, the confidence score for “Attachment” icon is 0.65, and the predetermined threshold value is 0.80.

In the above example, both confidence scores are below the predetermined threshold, the touch delegation module 112 classifies the touch as incorrect, indicating that the system may not confidently determine the intended UI object.

In another embodiment, when the confidence score meets or exceeds the predetermined threshold and the conflicting grid cell contains two or more UI objects, the touch delegation module 112 may present an expanded view of the one or more UI objects. The expanded view allows the user to make a more precise subsequent touch, or the touch delegation module 112 may automatically select the UI object with the highest confidence score.

In another example, the user taps on the “Reply” button, but the touch falls into a conflicting grid cell that overlaps the “Reply” button and the “Forward” button. The touch delegation module 112 may calculate the confidence scores confidence score for “Reply” button is 0.85, the confidence score for “Forward” button is 0.82, and the predetermined threshold value is 0.80.

In the above example, both the confidence scores exceed the threshold, therefore the view magnification module 112a of the touch delegation module 112 presents an expanded view that magnifies the “Reply” and “Forward” buttons which allows the user to make a more precise selection by tapping again on the intended button, or the touch delegation module 112 may automatically select the “Reply” button, which has the highest confidence score.

In yet another embodiment, when the confidence score is greater than or equal to the predetermined threshold and the conflicting grid cell corresponds to the intended UI object and at least one non-clickable area of the UI, the touch delegation module 112 may detect the touch on corresponding to the intended UI object.

In yet another example, the user taps near the “Send” button, and the touch overlaps the “Send” button and a non-clickable area of the UI (such as an empty part of the screen). The touch delegation module 112 may calculate the confidence score for the “Send” button as 0.88, which is greater than the predetermined threshold. Since the conflicting grid cell corresponds to the intended UI object (the “Send” button) and a non-clickable area, the touch delegation module 112 successfully detects the touch on the “Send” button and processes the user's action accordingly.

Upon detecting the intended UI, the user device 102 may perform the touch operation associated with the detected intended UI object.

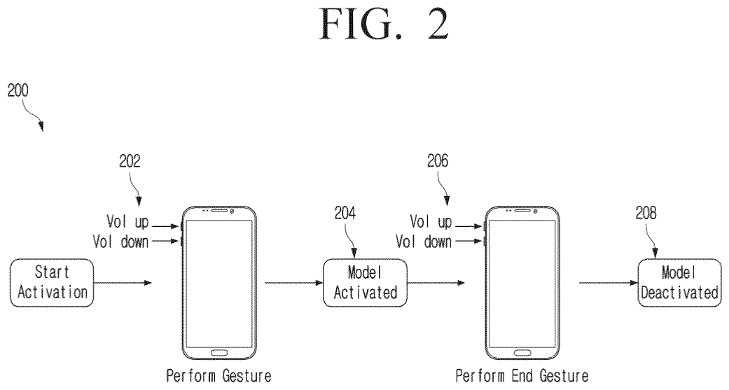

FIG. 2 illustrates a flow diagram 200 of the activation and deactivation of the non-conductive touch environment, according to an embodiment of the present disclosure.

In one embodiment, at step 202 the activation of the non-conductive touch environment in the user device 102 may be performed by pressing both volume up and volume down buttons simultaneously for a predefined time. In one embodiment, the predefined time may be 2 seconds. In another embodiment, the predefined time may be 3 seconds. At step 204, the user device 102 may provide feedback to the user. In one embodiment, the feedback may be vibration feedback. In another embodiment, the feedback may be a notification on the user device 102 upon activation.

At step 206, the non-conductive touch environment in the user device 102 may be deactivated by pressing both the volume up and the volume down buttons simultaneously for a predefined time. In one embodiment, the predefined time maybe 2 seconds. In another embodiment, the predefined time may be 3 seconds.

At step 208, upon the deactivation of the non-conductive touch environment, the user device 102 may provide feedback to the user. In one embodiment, the feedback may be vibration feedback. In another embodiment, the feedback may be a notification on the user device 102 upon deactivation.

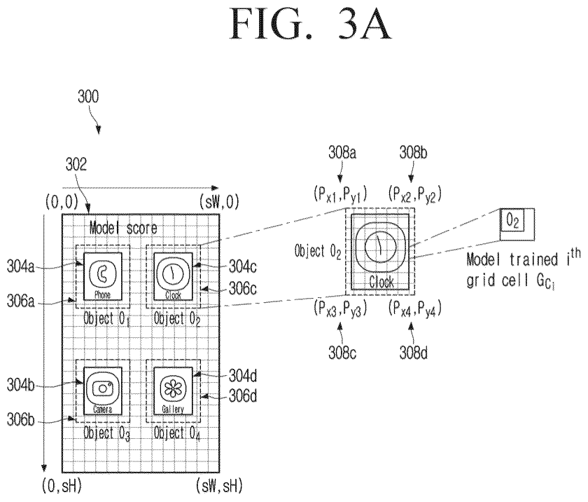

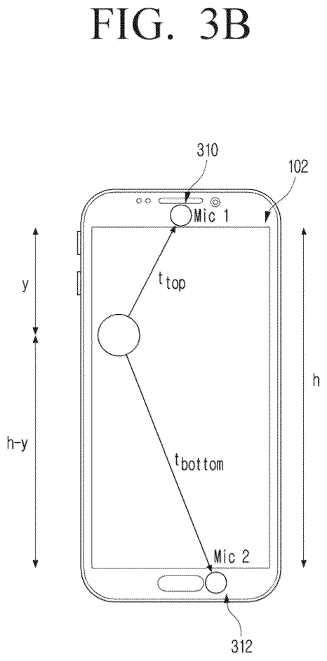

FIG. 3A illustrates a schematic diagram 300 depicting a segmentation of the one or more pixels and pixel mapping, according to an embodiment of the present disclosure.

In an embodiment of the present disclosure capturing one or more bitmap images such as 304a, 304b, 304c, and 304d of the UI layout 302 from the user device 102, utilizing a drawing cache. The drawing cache stores a version of the visual content at a specific time instance, allowing the bitmap image to accurately reflect the visual state of the UI. After capturing the bitmap image, an edge detection technique is applied to identify boundary pixels within the bitmap image, marking the edges of various UI objects. Following the marking the marking of the edges of the UI objects, the process detects the one or more UI object boundaries that correspond to these UI objects, outlining their shapes and distinguishing them from the surrounding elements.

Finally, a bounding box i.e., 306a, 306b, 306c, and 306d is computed for each detected UI object boundary to determine both the size and position of each view within the UI layout 302. The size of the UI object corresponds to its physical pixel dimensions in the bitmap image. The position of the UI object indicates the coordinates of the bounding box in the bitmap image. These dimensions are important for understanding how much space each UI element occupies within the overall UI layout (302), both in terms of visual rendering and interaction This results in a segmented one or more pixels where each UI object such as object 1, object 2, object 3, and the like is clearly defined and localized based on its spatial properties.

Further, a method includes detecting the intended UI object based on mapping the determined set of pixel coordinates to the dynamic mapping data present in a mapping table associated with the one or more UI objects. In an example, the pixel coordinates 308a, 308b, 308c, and 308d are mapped to the dynamic mapping data present in the mapping table associated with the one or more UI objects such that the intended UI object is detected.

The mapping table may be configured to include the dynamic mapping data that links specific the one or more pixel coordinates to corresponding UI objects. The mapping table may be further configured to store a pre-defined information about the positions of different UI elements on the screen. In an embodiment, the dynamic mapping data refers to the data that is not static. In other words, the dynamic mapping data may change based on various factors like screen resolution, window size, orientation, or the layout of UI objects in real-time.

In an embodiment, a dynamic mapping method starts by determining the one or more pixel coordinates (like 308a, 308b, 308c, and 308d). The one or more pixel coordinates may be captured when the user performs an action. For example, clicking or touching a specific part of the screen.

The next step involves mapping these pixel coordinates to the data present in the mapping table. The mapping table may contain the information necessary to associate the one or more pixel coordinates with the UI object. In an example, the one or more of pixel coordinates might correspond to the area occupied by a “Submit” button.

In example scenario where the user interacts with the UI object, like clicking on a button on a touch screen. The system 700 captures the one or more pixel coordinates of where the user touched. The dynamic mapping method maps these coordinates to the corresponding UI object by referring to the mapping table, which contains data linking specific areas of the screen to UI objects.

FIG. 3B illustrates an example embodiment for computing a vertical touch position on the user device 102 using dual-microphone sound data, according to an embodiment of the present disclosure.

The process of computing the vertical touch position on the user device 102 involves detecting the time difference between when the sound produced by a touch event reaches each microphone. The setup has a first microphone (Mic 1) 310 at the top and a second microphone (Mic 2) 312 at the bottom of the user device 102, and the goal is to use the time difference to determine the vertical position of the touch on the screen. In an embodiment of the present disclosure, to compute the vertical distance several parameters are involved, including the known height of the screen (h), the speed of sound in the medium (v_sound), and the absolute time difference (Δt) between the sound reaching each microphone. The unknown parameters are the time taken for the sound to reach each microphone (t_top and t_bottom) and the y-position of the touch.

The equations are derived for the time taken for the sound to reach each microphone: the time to reach the second microphone (Mic 2) 312 is given by t_bottom =y/v_sound, and for the first microphone (Mic 1) 310, it is t_top=(h−y)/v_sound. By calculating the difference in time (Δt) between the two microphones, the formula becomes Δt=(h−y)/v_sound-y/v_sound, which simplifies to Δt=(h−2y)/v_sound. Rearranging this equation allows for solving the unknown y-position: y=(h−v_sound×Δt)/ 2. This equation shows that the vertical position of the touch can be computed using the known values of the screen height, speed of sound, and time difference.

FIG. 3B illustrates the setup showing the total screen height h, the distance y between the top of the screen and the touch point, and the respective times for sound to reach each microphone. This method uses sound travel times to estimate the touch location, which can be useful in situations where acoustic data is more practical or accurate than visual sensors for detecting touch events. By using the difference in sound arrival times and applying the known parameters, the exact y-position of the touch can be calculated with precision.

FIG. 4A illustrates a block diagram 400 for determining a click pattern of an object, according to an embodiment of the present disclosure.

The click pattern of an object may be detected based on inputting the smoothed inertial sensor data 402 and processed microphone data 404 to a normalizer 406. The smoothed inertial sensor data 402 refers to a process of applying filters (such as moving average, Kalman filter, or low-pass filters) to the raw sensor data to reduce noise or irregular fluctuations. Further the processed microphone data 404 is a feature engineered i.e., transforming a raw data into meaningful features that can be used effectively by machine learning models. It involves selecting, modifying, or creating new input variables (features) from raw data to improve the performance and accuracy of a model.

Upon normalizing the smoothed inertial sensor data 402 and the processed microphone data 404, a segmentation module 408 may be configured to segment the smoothed inertial sensor data 402 and the processed microphone data 404 into one or more time intervals, with each interval representing a specific point in time during the user interaction. The one or more segmented time intervals captures individual moments when the user interacts with the user device 102, such as taps or gestures. The segmented data from the smoothed inertial sensor data 402 and the processed microphone data 404 is then concatenated into a single feature vector by a feature assembler 410 for each time interval, consolidating all relevant input data into a unified representation.

Further, the concatenated feature vectors are fed into a pre-trained artificial neural network (ANN) module 412. The pre-trained ANN module 412 processes the data to determine the click pattern 414, which might include information like how frequently and precisely the user taps or interacts with the screen. In another embodiment, the pre-trained ANN module 412 may also compute a model score, which helps evaluate the reliability and accuracy of the detected click pattern 414.

Once the click pattern 414 is determined the predicted view is generated by the predicted view module 110 for further processing. The determined click pattern 414, along with other contextual data, is then used to predict the user's actions, such as selecting a UI element or triggering a specific function on the user device 102. The one or more objects may be detected based on determining the click pattern 414. In an example, clicks shown in UI 416, such as click 1, click 2, and click 3 may be detected based on the click pattern 414.

FIG. 4B illustrates an example embodiment of a click pattern, according to an embodiment of the present disclosure. In an example embodiment, the click 1 indicates a click pattern 416a which may predict a calculator object. In another example embodiment, the click 2 indicates the click pattern 416b which may predict a Facebook™ object. In yet another example embodiment, the click 3 indicates a click pattern 416c which may predict a Google Assistant™ object and so on.

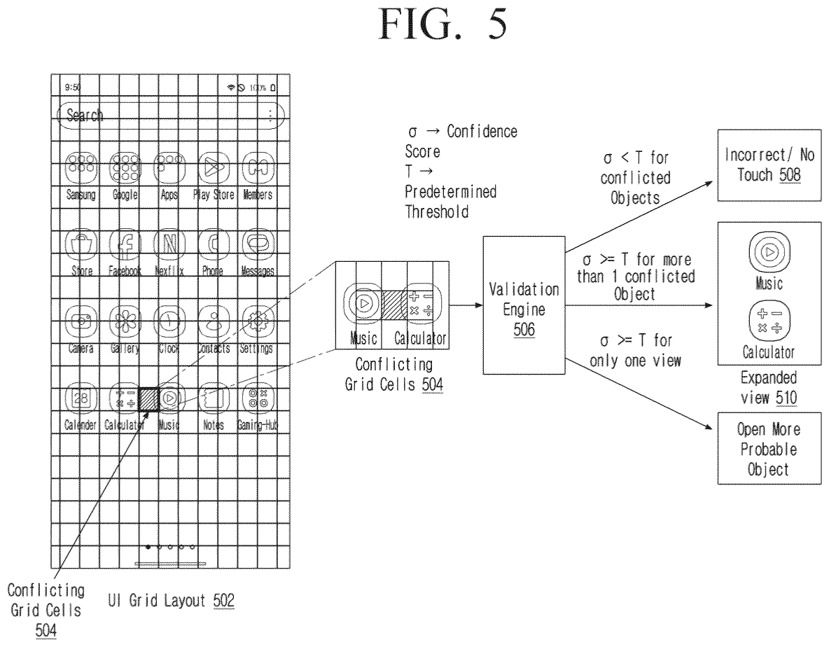

FIG. 5 illustrates a schematic diagram of a touch delegation, according to an embodiment of the present disclosure.

In an embodiment, when the predicted grid cell corresponds to at least one conflicting grid cell 504 in a UI grid layout 502, validation engine 506 initiates a process to detect the intended UI object from the one or more UI objects present within the conflicting area. This detection is performed by comparing the confidence score of the touch action with a predetermined threshold that is associated with the proximity of the touch. In one embodiment, when the confidence score is below the predetermined threshold, the touch delegation module 112 may classify the touch as incorrect 508.

In another embodiment, when the confidence score meets or exceeds the predetermined threshold and the conflicting grid cell contains two or more UI objects, the validation engine 506 may present an expanded view 510 of the one or more UI objects. The expanded view 510 allows the user to make a more precise subsequent touch, or the validation engine 506 may automatically select the UI object with the highest confidence score.

In yet another embodiment, when the confidence score is greater than or equal to the predetermined threshold and the conflicting grid cell 504 corresponds to the intended UI object and at least one non-clickable area of the UI, the validation engine 506 may detect the touch on corresponding to the intended UI object.

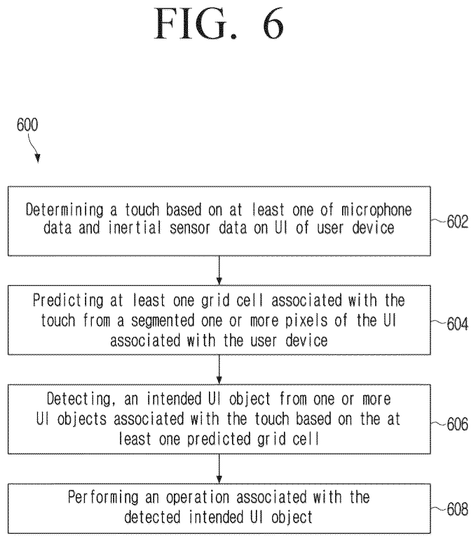

FIG. 6 illustrates a flowchart depicting a method 600 for performing an operation on the display of the user device 102. The method 600 may be implemented by the system 700, as disclosed in the present disclosure.

At step 602, the method 600 may include determining a touch based on at least one of the microphone data and the inertial sensor data on the user interface (UI) of the user device 102 by the user.

At step 604, the method 600 may include predicting at least one grid cell associated with the touch from a segmented one or more pixels of the UI associated with the user device 102. At step 606, the method 600 may include detecting, an intended UI object from one or more UI objects associated with the touch based on the at least one predicted grid cell.

FIG. 7 illustrates a system for performing an operation on a display of a user device, according to an embodiment of the present disclosure

The system 700 includes at least one processor 702 (also referred to as “the processor), memory 704, a storage component 706, an input component 708, an output component 710, a communication interface 712, and a bus 714.

The processor 702, as used herein, means any type of computational circuit that may include hardware elements and software elements. The processor 702 may be embodied as a multi-core processor, a single core processor, or a combination of one or more multi-core processors and/or one or more single core processors, a distributed processing system, or the like. The processor 702 may be a Central Processing Unit (CPU) a graphics processing unit (GPU), an accelerated processing unit (APU), an application-specific integrated circuit (ASIC), and/or another type of processing component.

The memory 704 includes at least one non-transitory computer readable medium. The memory 704 includes a random-access memory (RAM), a read only memory (ROM), and/or another type of dynamic or static storage device (e.g., a flash memory, a magnetic memory, and/or an optical memory) that stores information and/or instructions for use by processor 702. The memory 704 includes machine-readable instructions which are executable by the processor 702. These machine-readable instructions when executed by the processor 702 cause the processor 702 to perform one or more method steps of an embodiment described above.

The storage component 706 stores information and/or software related to the operation and use of the device. For example, the storage component 706 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

The input component 708 may be configured to receive information, such as user input. For example, the input component 708 may include, but not be limited to, a touch screen display, a keyboard, a keypad, a mouse, a button, a switch, and/or a microphone. The output component 710 is configured to convey information from the system 1440 to the user or other systems, utilizing a variety of devices and technologies tailored to specific application needs. The output component 710 may include visual output devices such as display screens (LCD, LED, OLED), projectors, and heads-up displays (HUDs) for presenting graphical or textual information. Additionally, auditory output through speakers and headphones provides audio feedback and alerts, while haptic output devices, like vibration motors in smartphones or game controllers, offer tactile feedback. Functionally, the output component serves multiple roles, including displaying graphical user interface (GUI) elements for user interaction, delivering notifications and alerts through sound, visual indicators, or vibrations, and rendering complex data visualizations like charts and graphs for easier comprehension.

In an embodiment, the output component 710 may be configured to receive processed data from the processor 702, which determines the information to be communicated, and the output component 710 may access memory 704 and storage component 706 to retrieve and display stored information such as documents, media files, or application states. Furthermore, the output component 710 may be configured to meet the specific requirements of different applications, such as high-resolution visual output and immersive audio for gaming systems or clear and precise data visualization and alert mechanisms for industrial control systems. Through these varied output methods, the output component 710 ensures effective communication of information, enhancing both system functionality and user experience.

The present disclosure provides various advantages:
The method (600) utilizes microphone data, along with inertial sensor data, to accurately determine touch inputs on the user interface, significantly reducing false touch detections and improving touch accuracy.

The integration of contextual touch interaction parameters, such as historical data and view clickability, allows the system (700) to better predict and detect UI objects, making it adaptable to a user's behaviour and the current context.

The method (600) provides an expanded view of conflicting UI objects in cases of low confidence scores, allowing users to make precise selections, thus improving usability in dense or complex UI layouts.

The method (600) supports voice inputs for touch determination, making it more versatile by combining multiple input modalities, such as voice and touch, for better interaction control.

Precise user interactions are ensured by predicting the grid cell associated with the touch and detecting the intended UI object, even in cases of ambiguous or conflicting touch inputs, thereby enhancing the overall user experience.

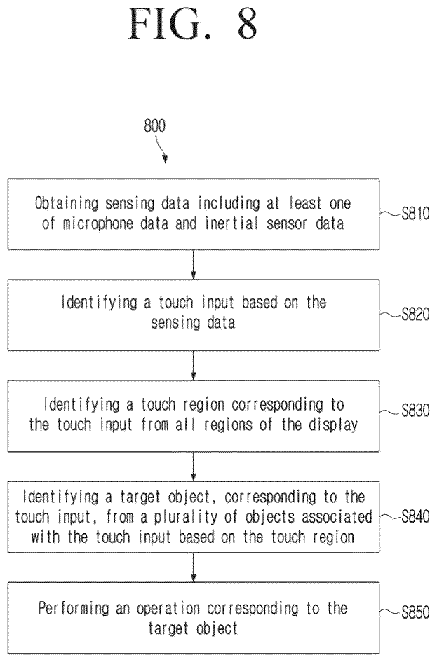

FIG. 8 illustrates a method for performing an operation on a display of a user device, according to an embodiment of the present disclosure.

In an embodiment, an electronic apparatus may include at least one processor including processing circuitry, memory configured to store instructions, and a display. The at least one processor may obtain sensing data including at least one of microphone data and inertial sensor data, identify a touch input based on the sensing data, identify a touch region corresponding to the touch input from all regions of the display, identify a target object, corresponding to the touch input, from a plurality of objects associated with the touch input based on the touch region, and perform an operation corresponding to the target object.

The sensing data may refer to data obtained from one or more sensors of the electronic apparatus.

The microphone data may refer to acoustic information obtained by a microphone of the electronic apparatus, the acoustic information including at least one of sound, noise, or a user voice.

The electronic apparatus may include a microphone. The at least one processor may obtain microphone data through the microphone. The electronic apparatus may include an inertial sensor. The at least one processor may obtain the inertial sensor data through the inertial sensor.

The inertial sensor data may refer to motion-related measurement values obtained from an inertial sensor, such as an accelerometer or a gyroscope, including at least one of acceleration, angular velocity, and orientation information of the electronic apparatus.

The at least one processor may obtain touch sound based on the microphone data. The at least one processor may identify touch region(or touch position) based on the touch sound.

The at least one processor may obtain touch pattern based on the inertial sensor data. The at least one processor may identify touch region(or touch position) based on the touch pattern.

The touch input may refer to an input generated by a user's interaction with the electronic apparatus.

The object may be described as UI(User Interface) object, object element or touch object.

The region may be described as area or position.

The touch region may refer to an area of the display corresponding to the location of the touch input.

The target object may refer to a user interface (UI) element or graphical object displayed on the display, which is determined to correspond to the touch input and is associated with an operation to be executed.

The at least one processor may control the display to display a screen including the plurality of objects, and based on the touch input being identified, identify the target object among the plurality of objects.

The at least one processor may identify the touch region based on at least one grid cell corresponding to the touch input from a plurality of grid cells associated with at least one of pixels of the display, and identify the target object based on the at least one grid cell corresponding to the touch input.

The grid cell may refer to a subdivided area of the display defined by one or more pixels, the grid cell representing a portion of the display used for identifying a touch region.

The at least one processor may obtain at least one of a click pattern, a model score and a plurality of contextual touch interaction parameters, obtain a confidence score corresponding to the touch input based on the at least one of the click pattern, the model score and the plurality of contextual touch interaction parameters, and identify the touch region based on the confidence score.

The click pattern may refer to a data pattern associated with a user's interaction derived from the sensing data, the pattern representing temporal or spatial characteristics of a click or touch action.

The model score may refer to a numerical value or probability output generated by a trained model, such as a machine learning model, based on the sensing data, indicating a likelihood of the touch input corresponding to a particular region or object.

The confidence score may be described as reliability score, probability score, prediction confidence value or confidence level.

The confidence score may refer to a numerical value or metric calculated based on at least one of the click pattern, the model score, and contextual parameters, indicating a degree of certainty that the touch input corresponds to a specific grid cell or target object.

The at least one processor may normalize the sensing data to a single scale, segment the normalized sensing data for one or more time intervals, wherein the one or more time intervals indicate individual time points at which the normalized sensing data are segmented for further processing, concatenate the segmented data into a single feature vector for each time interval, and identify the at least one of the click pattern and the model score using a pre-trained artificial neural network (ANN) module based on the concatenated data.

The pre-trained artificial neural network (ANN) module may refer to a computational model trained in advance using training data. The module is configured to recognize patterns in the sensing data and to output at least one of the click pattern and the model score based on input feature vectors.

The plurality of contextual touch interaction parameters includes at least one of a clickability data indicating whether a grid cell is clickable or not, a historical data representing user interactions indicating regions which are intentionally frequently touched, and a contextual data indicating a relationship between the touch input and a current context.

The clickability data may refer to data indicating whether a grid cell or region of the display is capable of receiving a valid touch input based on an associated UI object.

The historical data may refer to information representing previous user interactions with the electronic apparatus, including frequencies and locations of touches, which may indicate intentionally frequently touched regions.

The contextual data may refer to information representing a relationship between the touch input and a current operational context of the electronic apparatus, including environmental or situational conditions.

The contextual touch interaction parameters may refer to data reflecting additional contextual information associated with the touch input.

The at least one processor may, based on at least two target objects corresponding to the touch input being identified, identify at least one conflicting grid cell.

The at least one processor may, based on the at least one conflicting grid cell being identified, obtain a comparison result by comparing the confidence score with a predetermined threshold associated with a touch proximity, and identify the touch region based on the comparison result.

The conflicting grid cell may refer to a grid cell that corresponds to at least two UI objects such that more than one candidate target object may be associated with the same grid cell. The conflicting grid cell may refer to a grid cell associated with two or more UI objects. The conflicting grid cell may refer to a grid cell simultaneously corresponding to two or more UI objects.

The conflicting grid cell may be described as an overlapping grid cell, an ambiguous grid cell, a multi-mapped grid cell, or a shared grid cell.

The at least one processor may, based on the confidence score being smaller than the predetermined threshold, identify the touch input as an incorrect touch.

The at least one processor may, based on the confidence score being equal or greater than the predetermined threshold, control the display to display a screen including the at least two objects in an enlarged size.

In an embodiment, a method of controlling an electronic apparatus, the method may include obtaining sensing data including at least one of microphone data and inertial sensor data (S810), identifying a touch input based on the sensing data (S820), identifying a touch region corresponding to the touch input from all regions of the display (S830), identifying a target object, corresponding to the touch input, from a plurality of objects associated with the touch input based on the touch region (S840), and performing an operation corresponding to the target object (S850).

The method may further include displaying a screen including the plurality of objects. The identifying the target object includes: based on the touch input being identified, identifying the target object among the plurality of objects.

The identifying the target region may include identifying the touch region based on at least one grid cell corresponding to the touch input from a plurality of grid cells associated with at least one of pixels of the display. The identifying the target object may include identifying the target object based on the at least one grid cell corresponding to the touch input.

The identifying the target region includes obtaining at least one of a click pattern, a model score and a plurality of contextual touch interaction parameters, obtaining a confidence score corresponding to the touch input based on the at least one of the click pattern, the model score and the plurality of contextual touch interaction parameters, and identifying the touch region based on the confidence score.

The obtaining at least one of the click pattern, the model score includes normalizing the sensing data to a single scale, segmenting the normalized sensing data for one or more time intervals, wherein the one or more time intervals indicate individual time points at which the normalized sensing data are segmented for further processing, concatenating the segmented data into a single feature vector for each time interval and obtaining the at least one of the click pattern and the model score using a pre-trained artificial neural network (ANN) module based on the concatenated data.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

What is claimed is:

1. An electronic apparatus comprising:
at least one processor comprising processing circuitry,
memory configured to store instructions, and
a display,
wherein the instructions, when executed by the at least one processor individually or collectively, cause the electronic apparatus to:
obtain sensing data comprising at least one of microphone data and inertial sensor data,
identify a touch input on the display based on the sensing data,
identify a touch region corresponding to the touch input from among regions of the display,
identify a target object corresponding to the touch input, from among a plurality of objects associated with the touch input based on the touch region, and
perform an operation corresponding to the target object.

2. The electronic apparatus according to claim 1, wherein the instructions, when executed by the at least one processor individually or collectively, cause the electronic apparatus to:
control the display to display a screen comprising the plurality of objects,
based on the touch input being identified, identify the target object from among the plurality of objects.

3. The electronic apparatus according to claim 1, wherein the instructions, when executed by the at least one processor individually or collectively, cause the electronic apparatus to:
identify the touch region based on at least one grid cell corresponding to the touch input, from among a plurality of grid cells associated with at least one of pixels of the display, and
identify the target object based on the at least one grid cell corresponding to the touch input.

4. The electronic apparatus according to claim 3, wherein the instructions, when executed by the at least one processor individually or collectively, cause the electronic apparatus to:
obtain at least one of a click pattern, a model score and a plurality of contextual touch interaction parameters,
obtain a confidence score corresponding to the touch input based on the at least one of the click pattern, the model score and the plurality of contextual touch interaction parameters, and
identify the touch region based on the confidence score.

5. The electronic apparatus according to claim 4, wherein the instructions, when executed by the at least one processor individually or collectively, cause the electronic apparatus to:
normalize the sensing data to a single scale,
segment the normalized sensing data for one or more time intervals indicating individual time points at which the normalized sensing data are segmented for further processing,
concatenate the segmented data into a single feature vector for each time interval of the one or more time intervals, and
identify the at least one of the click pattern and the model score using a pre-trained artificial neural network module based on the concatenated segmented data.

6. The electronic apparatus according to claim 4, wherein the plurality of contextual touch interaction parameters comprises at least one of:
clickability data indicating whether a grid cell is clickable,
historical data representing user interactions indicating regions which are intentionally frequently touched, and
contextual data indicating a relationship between the touch input and a current context.

7. The electronic apparatus according to claim 4, wherein the instructions, when executed by the at least one processor individually or collectively, cause the electronic apparatus to:
based on at least two target objects corresponding to the touch input being identified, identify at least one conflicting grid cell from among the plurality of grid cells.

8. The electronic apparatus according to claim 7, wherein the instructions, when executed by the at least one processor individually or collectively, cause the electronic apparatus to:
based on the at least one conflicting grid cell being identified, obtain a comparison result by comparing the confidence score with a predetermined threshold associated with a touch proximity, and
identify the touch region based on the comparison result.

9. The electronic apparatus according to claim 8, wherein the instructions, when executed by the at least one processor individually or collectively, cause the electronic apparatus to:
based on the confidence score being smaller than the predetermined threshold, identify the touch input as an incorrect touch.

10. The electronic apparatus according to claim 8, wherein the instructions, when executed by the at least one processor individually or collectively, cause the electronic apparatus to:
based on the confidence score being equal or greater than the predetermined threshold, control the display to display a screen comprising the at least two objects in an enlarged size.

11. A method of controlling an electronic apparatus, the method comprising:
obtaining sensing data comprising at least one of microphone data and inertial sensor data,
identifying a touch input on a display of the electronic device based on the sensing data,
identifying a touch region corresponding to the touch input from among regions of the display,
identifying a target object, corresponding to the touch input, from among a plurality of objects associated with the touch input based on the touch region, and
performing an operation corresponding to the target object.

12. The method according to claim 11, further comprising:
displaying, by the display, a screen comprising the plurality of objects,
wherein the identifying the target object comprises:
based on the touch input being identified, identifying the target object from among the plurality of objects.

13. The method according to claim 11, wherein the identifying the touch region comprises:
identifying the touch region based on at least one grid cell corresponding to the touch input from among a plurality of grid cells associated with at least one of pixels of the display, and
wherein the identifying the target object comprises:
identifying the target object based on the at least one grid cell corresponding to the touch input.

14. The method according to claim 13, wherein the identifying the touch region comprises:
obtaining at least one of a click pattern, a model score and a plurality of contextual touch interaction parameters,
obtaining a confidence score corresponding to the touch input based on the at least one of the click pattern, the model score and the plurality of contextual touch interaction parameters, and
identifying the touch region based on the confidence score.

15. The method according to claim 14, wherein the obtaining at least one of the click pattern, the model score, and the plurality of contextual touch interaction parameters comprises:
normalizing the sensing data to a single scale,
segmenting the normalized sensing data for one or more time intervals, wherein the one or more time intervals indicate individual time points at which the normalized sensing data are segmented for further processing,
concatenating the segmented data into a single feature vector for each time interval of the one or more time intervals, and
obtaining the at least one of the click pattern and the model score using a pre-trained artificial neural network module based on the concatenated data.

16. The method according to claim 14, wherein the plurality of contextual touch interaction parameters comprises at least one of:
clickability data indicating whether a grid cell is clickable,
historical data representing user interactions indicating regions which are intentionally frequently touched, and
contextual data indicating a relationship between the touch input and a current context.

17. The method according to claim 14, wherein the identifying the touch region further comprises:
based on at least two target objects corresponding to the touch input being identified, identifying at least one conflicting grid cell from among the plurality of grid cells.

18. The electronic apparatus according to claim 17, wherein the identifying the touch region further comprises:
based on the at least one conflicting grid cell being identified, obtaining a comparison result by comparing the confidence score with a predetermined threshold associated with a touch proximity, and
identifying the touch region based on the comparison result.

19. The method according to claim 18, wherein the identifying the touch region further comprises:
based on the confidence score being smaller than the predetermined threshold, identify the touch input as an incorrect touch.

20. The method according to claim 18, wherein the identifying the touch region further comprises:
based on the confidence score being equal or greater than the predetermined threshold, control the display to display a screen comprising the at least two objects in an enlarged size.
